(19) United States
(12) Patent Application Publication
(10) Pub. No.: US 2013/0069360 A1
(43) Pub. Date: Mar. 21, 2013

(54) SECURITY DOCUMENT WITH INTEGRATED SECURITY DEVICE AND METHOD OF MANUFACTURE

(71) Applicants: Gary Fairless Power, Craigieburn (AU); Odisea Batistatos, Craigieburn (AU); Patrick Swift, Craigieburn (AU); Karlo Ivan Jolic, Craigieburn (AU)

(72) Inventors: Gary Fairless Power, Craigieburn (AU); Odisea Batistatos, Craigieburn (AU); Patrick Swift, Craigieburn (AU); Karlo Ivan Jolic, Craigieburn (AU)

(73) Assignee: SECURENCY INTERNATIONAL PTY LTD., Craigieburn (AU)

(21) Appl. No.: 13/636,656

(22) PCT Filed: Mar. 24, 2011
(86) PCT No.: PCT/AU2011/000337

§ 371 Date: Nov. 30, 2012

(30) Foreign Application Priority Data
Mar. 24, 2010 (AU) 2010901243

(51) Int. Cl. B42D 15/00

(52) U.S. Cl. CPC B42D 15/00
USPC 283/85; 427/487

(57) ABSTRACT

A security document (1) is provided having a substrate (4) and an integral security device (10) which includes an image layer (12) and a focussing layer (11). each formed from a radiation curable ink layer embossed with relief formations (13; 15). The first radiation curable layer embossed with relief formations (13) to form the image layer (12) is provided on a first surface of the document, and the second radiation curable layer (11) embossed with focussing element relief formations (15) is provided on a second surface of the document. The first and second surfaces are separated by a predetermined distance D to produce a visible optical effect when viewing the image layer (12) through the focussing layer (11). In preferred embodiments, at least one of the first and second radiation curable layers is embossed with diffractive relief structures and high refractive index or reflective coatings may be applied to the embossed relief formations in the image layer (12) and/or the focussing layer (11). The invention allows security devices to be integrated in a security document, such as a banknote, in a cost-effective manner, without substantially increasing the thickness of the document.

### FIELD OF THE INVENTION

This invention relates to security documents and tokens, and is particularly concerned with providing a security document with an integrated security device or feature, and also an improved method of manufacturing such a security document.

### DEFINITIONS

Security Document

As used herein the term security document includes all types of documents and tokens of value and identification documents including, but not limited to the following: items of currency such as banknotes and coins, credit cards, cheques, passports, identity cards, securities and share certificates, driver's licenses, deeds of title, travel documents such as airline and train tickets, entrance cards and tickets, birth, death and marriage certificates, and academic transcripts.

The invention is particularly, but not exclusively, applicable to security documents such as banknotes or identification documents such as identity cards or passports formed from a substrate to which one or more layers of printing are applied.

Substrate

As used herein, the term substrate refers to the base material from which the security document or token is formed. The base material may be paper or other fibrous material such as cellulose; a plastic or polymeric material including but not limited to polypropylene (PP), polyethylene (PE), polycarbonate (PC), polyvinyl chloride (PVC), polyethylene terephthalate (PET); or a composite material of two or more materials, such as a laminate of paper and at least one plastic material, or of two or more polymeric materials.

The use of plastic or polymeric materials in the manufacture of security documents pioneered in Australia has been very successful because polymeric banknotes are more durable than their paper counterparts and can also incorporate new security devices and features. One particularly successful security feature in polymeric banknotes produced for Australia and other countries has been a transparent area or “window”.

Transparent Windows and Half Windows

As used herein the term window refers to a transparent or translucent area in the security document compared to the substantially opaque region to which printing is applied. The window may be fully transparent so that it allows the transmission of light substantially unaffected, or it may be partly transparent or translucent partially allowing the transmission of light but without allowing objects to be seen clearly through the window area.

A window area may be formed in a polymeric security document which has at least one layer of transparent polymeric material and one or more opacifying layers applied to at least one side of a transparent polymeric substrate, by omitting least one opacifying layer in the region forming the window area. If opacifying layers are applied to both sides of a transparent substrate a fully transparent window may be formed by omitting the opacifying layers on both sides of the transparent substrate in the window area.

A partly transparent or translucent area, hereinafter referred to as a “half-window”, may be formed in a polymeric security document which has opacifying layers on both sides by omitting the opacifying layers on one side only of the security document in the window area so that the “half-window” is not fully transparent, but allows some light to pass through without allowing objects to be viewed clearly through the half-window.

Alternatively, it is possible for the substrates to be formed from an substantially opaque material, such as paper or fibrous material, with an insert of transparent plastics material inserted into a cut-out, or recess in the paper or fibrous substrate to form a transparent window or a translucent half-window area.

Opacifying Layers

One or more opacifying layers may be applied to a transparent substrate to increase the opacity of the security document. An opacifying layer is such that

L_{T}<L₀,

where Lₒ is the amount of light incident on the document, and L_{T} is the amount of light transmitted through the document. An opacifying layer may comprise any one or more of a variety of opacifying coatings. For example, the opacifying coatings may comprise a pigment, such as titanium dioxide, dispersed within a binder or carrier of heat-activated cross-linkable polymeric material. Alternatively, a substrate of transparent plastic material could be sandwiched between opacifying layers of paper or other partially or substantially opaque material to which indicia may be subsequently printed or otherwise applied.

Security Device or Feature

As used herein the term security device or feature includes any one of a large number of security devices, elements or features intended to protect the security document or token from counterfeiting, copying, alteration or tampering. Security devices or features may be provided in or on the substrate of the security document or in or on one or more layers applied to the base substrate, and may take a wide variety of forms, such as security threads embedded in layers of the security document; security inks such as fluorescent, luminescent and phosphorescent inks, metallic inks, iridescent inks, photochromic, thermochromic, hydrochromic or piezochromic inks; printed and embossed features, including relief structures; interference layers; liquid crystal devices; lenses and lenticular structures; optically variable devices (OVDs) such as diffractive devices including diffraction gratings, holograms and diffractive optical elements (DOEs).

Focal Point Size

As used herein, the term focal point size refers to the dimensions, usually an effective diameter or width, of the geometrical distribution of points at which rays refracted through a lens intersect with an object plane at a particular viewing angle. The focal point size may be inferred from theoretical calculations, ray tracing simulations, or from actual measurements.

Focal Length f

In the present specification, focal length, when used in reference to a microlens in a lens array, means the distance from the vertex of the microlens to the position of the focus given by locating the maximum of the power density distribution when collimated radiation is incident from the lens side of the array (see T. Miyashita, “Standardization for microlenses and microlens arrays” (2007) Japanese Journal of Applied Physics 46, p 5391).

Sag Height s

The sag height or surface sag s of a lenslet is the distance from the apex to a point on the axis intersected by the shortest line from the edge of a lenslet extending perpendicularly through the axis.

Lobe Angle

The lobe angle of a lens is the entire viewing angle formed by the lens.

### BACKGROUND TO THE INVENTION

One type of security device which has previously been proposed for use in security documents is disclosed in U.S. Pat. No. 5,712,731 (Drinkwater) which involves a combination of microlenses and microimages for generating optically variable effects. In U.S. Pat. No. 5,712,731 the microimages are formed by printing on a surface of a substrate and the microlenses can be formed in a separate component or in a transparent plastics sheet bonded to the microimages. A slight mismatch between the pitch or rotational alignment of the microimages and microlenses can produce optically variable effects, such as a magnified image (known as a moiré magnifier, as described in M. Nutley et al, “The moiré magnifier”, Pure and Applied Optics vol. 3, pp 133-142 (1994)). These known security devices may produce images which appear to move and/or float below or above the plane of the device as the observing angle changes.

A disadvantage of these known security devices is that they are not very suitable for incorporation in a thin, flexible security document, such as a banknote or the like. Also, the optically variable effects produced are monochromatic, and there is a limit to the size of microimages which can be produced by traditional printing methods such as gravure, flexographic and intaglio printing.

It has also been proposed to form microimages in an optically variable security device using laser technology, eg by directing a laser beam through microlenses onto a laser absorbent layer. However, such a technique only produces monochromatic images.

US 2008/0160226 discloses a security element having a first authenticating feature and a second authenticating feature. The first feature comprises a plurality of focussing elements in a first grid and a plurality of microscopic structures in a second grid. The microscopic structures are magnified when viewed through the focussing elements. The second authenticating element is machine and/or visually verifiable and is not influenced by the focussing elements of the first authenticating feature. Many of the various embodiments of security elements in US 2008/0160226 include an adhesive layer for transferring the security element to a document. Other embodiments include two carrier substrates, one for the focussing elements, and the other for the microstructures. In some embodiments the microstructures are embossed, and in other embodiments they are printed. The security element disclosed in US 2008/0160226 exhibits a total thickness of less than 50 μm to make it suitable especially for attachment a security paper, valuable document or the like. However, this can impose restraints on the size and focal length of the focussing elements and the size and resolution of the microstructures.

It is therefore desirable to provide a security document and method of manufacture in which at least some of the disadvantages of the prior art are alleviated. It is also desirable to provide a security document which incorporates a device which can produce optically variable effects similar to those of a combination of microlenses and microimages with an enhanced visual effect. It is further desirable to provide an improved method for manufacturing such a security document incorporating such a security device.

According to one aspect of the invention there is provided a security document comprising a substrate provided with an integral security device formed on the substrate, wherein the security device comprises an image layer and a focussing layer, the image layer including a plurality of embossed relief formations in a first radiation curable ink layer on a first surface of the document, the focussing layer including a plurality of embossed focussing element relief formations in a second radiation curable ink layer on a second surface, wherein the total thickness of the document falls substantially within the range from 60 to 140 μm and said first and second surfaces are separated by a predetermined distance greater than 50 μm to produce a visible optical effect when viewing the image layer through the focussing layer.

According to another aspect of the invention there is provided a method of manufacturing a security document with an integral security device including the steps of:

applying a first embossable radiation curable ink layer to a surface on one side of the document;

embossing the first radiation curable ink layer with a plurality of relief formations and curing with radiation to form an image layer; and

applying a second embossable radiation curable ink layer to a second surface;

embossing the second radiation curable layer with embossed focussing element relief formations and curing with radiation to form a focussing layer,

wherein the total thickness of the document falls substantially within the range from 60 to 140 μm and the first and second surfaces are separated by a predetermined distance greater than 50 μm to produce a visible optical effect when viewing the image layer through the focussing layer.

Preferably, the total thickness of the security document falls substantially within the range from about 70 to 120 μm, and more preferably from about 80 to 100 μm, the preferred thickness range for a banknote. The first and second surfaces on which the image layer and focussing layer are respectively provided are preferably separated by a distance falling substantially within the range from about 60 to 100 μm, and more preferably between about 65 and 90 μm.

The method of forming the relief formations in the image layer by embossing a radiation curable ink is particularly advantageous in that it enables image elements of a high resolution to be integrally formed in a security document, such as a banknote. For example, embossings having dimensions in the nanometer (nm) range can be formed by the “soft embossing” technique of embossing into a radiation curable ink layer and substantially simultaneously curing the radiation curable ink with radiation such as UV radiation, X-rays or electron beams.

In a particularly preferred embodiment, the plurality of image relief formations in the image layer include embossed diffractive structures.

A security device having an image layer including a plurality of image elements formed as embossed diffractive structures with a focussing layer separated from the image layer by a predetermined distance, eg the thickness of a transparent substrate of a security document, allows a variety of optically variable effects to be produced. In particular a visible optical effect in the form of a coloured image can be produced which may be combined with other effects such as a magnified moiré effect, three dimensional effects and moving or floating images.

In accordance with a further aspect of the invention, there is provided a security document incorporating a security device comprising an image layer including a plurality of relief formations applied to a first surface of the device, and a focussing layer including a plurality of diffractive structures formed on a second surface of the device, said first and second surfaces being separated by a predetermined distance whereby a visible optical effect in the form of a coloured image is produced when viewing the image layer through the focussing layer.

If the image layer includes diffractive structures, they may be used to form image elements on a non-diffractive background. The non-diffractive background may take various forms. For example, it may be a transparent background, an opaque and diffusely scattering (matte) background, or a specularly reflecting background.

Alternatively, the diffractive structures may form the background, while the image elements are formed by non-diffractive areas on the background, i.e. areas which are devoid of diffractive structures.

The plurality of relief element formations in the focussing layer and/or image layer may include microlens structures and/or micromirror elements. The plurality of relief element formations may instead, or additionally, include formations which form at least one Fresnel lens, zone plate or photon sieve.

The use of a diffractive focussing structure such as a Fresnel lens or zone plate can be particularly advantageous when integrated in a security document, because devices containing such structures are considerably thinner than their refractive counterparts. A diffractive magnifying structure in the form of a photon sieve confers a further advantage in that it provides substantially the same functionality as a zone plate, but has smaller contiguous areas, thereby allowing for greater ease of production when using embossing methods.

The visible optical effect produced when viewing the relief formations of the image layer through the focussing layer may include a magnified moiré effect, a three-dimensional effect, a moving or floating image effect, or a combination of these. Because the relief formations are applied to the device by an embossing method, a wide variety of structures (producing a correspondingly wide variety of optical effects) may be applied to the device in close spatial relationship, e.g. as mutually adjacent or interleaved structures, in a single step.

In preferred embodiments, the substrate of the security document may be formed from a transparent material, with the relief formations of the image layer being embossed into a radiation curable layer applied on one side of the substrate. The relief formations of the focussing layer may then be embossed into a radiation curable layer applied on the opposite side of the substrate.

In a preferred arrangement, the thicknesses of the transparent material and of the radiation curable layers on opposite sides of the substrate determine the predetermined separation of the image layer and focussing layer.

In an alternative embodiment, the relief formations of the image layer and the focussing layer are embossed into radiation curable layers applied to surfaces on the same side of the substrate forming the security document, said surfaces being separated by a substantially transparent intermediate layer.

At least one metallic or high refractive index (HRI) coating may be applied to the embossed relief formations of the image layer and/or the focussing layer. A reflective coating of this nature improves the visibility of the optical effect produced by the device when viewed in reflection mode through the focussing layer.

With this arrangement, the substrate of the security document may be transparent, translucent or opaque. The thicknesses of the substantially transparent intermediate layer, the radiation curable layers and any high refractive index coatings may determine the predetermined separation of the image layer and/or the focussing layer.

Opaque substrates suitable for use with certain of the above embodiments include paper and paper/polymer hybrid substrates.

It is particularly preferred that the security device be integrated within a substantially transparent window of the security document, in order to provide another layer of security over and above the security device itself.

Embossable Radiation Curable Ink

The term embossable radiation curable ink used herein refers to any ink, lacquer or other coating which may be applied to the substrate in a printing process, and which can be embossed while soft to form a relief structure and cured by radiation to fix the embossed relief structure. The curing process does not take place before the radiation curable ink is embossed, but it is possible for the curing process to take place either after embossing or at substantially the same time as the embossing step. The radiation curable ink is preferably curable by ultraviolet (UV) radiation. Alternatively, the radiation curable ink may be cured by other forms of radiation, such as electron beams or X-rays.

The radiation curable ink is preferably a transparent or translucent ink formed from a clear resin material. Such a transparent or translucent ink is particularly suitable for printing light-transmissive security elements such as numerical-type DOEs and lens structures.

In one particularly preferred embodiment, the transparent or translucent ink preferably comprises an acrylic based UV curable clear embossable lacquer or coating.

Such UV curable lacquers can be obtained from various manufacturers, including Kingfisher Ink Limited, product ultraviolet type UVF-203 or similar. Alternatively, the radiation curable embossable coatings may be based on other compounds, eg nitro-cellulose.

The radiation curable inks and lacquers used in the invention have been found to be particularly suitable for embossing microstructures, including diffractive structures such as DOEs, diffraction gratings and holograms, and microlenses and lens arrays. However, they may also be embossed with larger relief structures, such as non-diffractive optically variable devices.

The ink is preferably embossed and cured by ultraviolet (UV) radiation at substantially the same time. In a particularly preferred embodiment, the radiation curable ink is applied and embossed at substantially the same time in a Gravure printing process.

Preferably, in order to be suitable for Gravure printing, the radiation curable ink has a viscosity falling substantially in the range from about 20 to about 175 centipoise, and more preferably from about 30 to about 150 centipoise. The viscosity may be determined by measuring the time to drain the lacquer from a Zahn Cup #2. A sample which drains in 20 seconds has a viscosity of 30 centipoise, and a sample which drains in 63 seconds has a viscosity of 150 centipoise.

With some polymeric substrates, it may be necessary to apply an intermediate layer to the substrate before the radiation curable ink is applied to improve the adhesion of the embossed structure formed by the ink to the substrate. The intermediate layer preferably comprises a primer layer, and more preferably the primer layer includes a polyethylene imine. The primer layer may also include a cross-linker, for example a multi-functional isocyanate. Examples of other primers suitable for use in the invention include: hydroxyl terminated polymers; hydroxyl terminated polyester based co-polymers; cross-lined or uncross-linked hydroxylated acrylates; polyurethanes; and UV curing anionic or cationic acrylates. Examples of suitable cross-linkers include: isocyanates; polyaziridines; ziconium complexes; aluminium acetylacetone; melamines; and carbodi-imides.

The type of primer may vary for different substrates and embossed ink structures. Preferably, a primer is selected which does not substantially affect the optical properties of the embossed ink structure.

In another possible embodiment the radiation curable ink may include metallic particles to form a metallic ink composition which is both printable and embossable. Such a metallic ink composition may be used to print a reflective security element, such as a diffraction grating or hologram. Alternatively, a transparent ink, e.g. formed from a clear resin, may be applied on one side of the substrate, with or without an intermediate primer layer, the transparent ink then being embossed and cured with radiation and a metallic ink composition subsequently applied to the embossed transparent ink in a printing process, if it is desired to form a reflective security element as part of the security device.

It is also possible for the metallic ink composition to be applied in a layer which is sufficiently thin to allow the transmission of light.

When a metallic ink is used, it preferably comprises a composition including metal pigment particles and a binder. The metal pigment particles are preferably selected from the group comprising: aluminium, gold, silver, platinum, copper, metal alloy, stainless steel, nichrome and brass. The metallic ink preferably has a low binder content and a high pigment to binder ratio. Examples of metallic ink compositions suitable for use in the present invention are described in WO2005/049745 of Wolstenholme International Limited, which describes coating compositions suitable for use in coating a diffraction grating comprising metal pigment particles and a binder, wherein the ratio of pigment to binder is sufficiently high as to permit the alignment of the pigment particles to the contours of the diffraction grating. Suitable binders may comprise any one or more selected from the group comprising nitrocellulose, ethyl cellulose, cellulose acetate, cellulose acetate propionate (CAP), cellulose acetate butyrate (CAB), alcohol soluble propionate (ASP), vinyl chloride, vinyl acetate co-polymers, vinyl acetate, vinyl, acrylic, polyurethane, polyamide, rosin ester, hydrocarbon, aldehyde, ketone, urethane, polyethyleneterephthalate, terpene phenol, polyolefin, silicone, cellulose, polyamide and rosin ester resins. In one particularly preferred metallic ink composition, the binder comprises nitro cellulose and polyurethane.

The pigment to binder ratio preferably falls substantially within the range from about 5:1 to about 0.5:1 by weight, and more preferably falls substantially within the range from about 4:1 to about 1:1 by weight.

The metal pigment content by weight of the composition is preferably less than about 10%, and more preferably less than about 6%. In particularly preferred embodiments, the pigment content by weight of the composition falls substantially in the range from about 0.2% to about 6%, and more preferably from about 0.2% to about 2%.

The average particle diameter may be in the range from about 2 μm to about 20 μm, preferably in the range from about 5 μm to about 20 μm, and more preferably in the range from about 8 μm to about 15 μm.

The thickness of the pigment particles is preferably less than about 100 nm and more preferably less than about 50 nm. In one embodiment, the thickness of the pigment particles falls substantially within the range from 10-50 nm. In another embodiment, the thickness of the pigment particles falls substantially within the range from 5-35 nm, and in another embodiment the average thickness of the pigment particles falls substantially within the range from 5-18 nm.

Embossable UV curable ink compositions such as described above have been found to be particularly suitable for embossing to form optically diffractive security devices, such as diffraction gratings, holograms and diffractive optical elements.

In the case of a half-window in which the transparent region is covered on one side by at least one opacifying layer, a security device formed from an embossed metallic ink may be a reflective device which is only visible in the half-window from the opposite side of the substrate, which is not covered by an opacifying layer in the half-window area.

It is also possible for the opacifying layer, which covers the half-window area on one side of the substrates, to allow the partial transmission of light so that the security device formed by the embossed ink is partially visible in transmission from the side, which is covered by the opacifying layer in the half-window area.

In the case of a flexible security document, such as a bank note or the like, which is foldable, if the focussing layer is provided on a first surface of the document in a full window area, the image layer may be provided on another part of the document which is laterally spaced from the focussing layer and located on the opposite surface of the document, whereby when the lens layer is superimposed over the image layer, e.g. by folding, the image layer can be viewed through the focussing layer and the visible optical effect becomes apparent.

### BRIEF DESCRIPTION OF THE DRAWINGS

Some preferred embodiments of the present invention will now be described, by way of example only, with reference to the accompanying drawings, in which:

FIG. 1 is a schematic section through a security document having an integrated security device according to one embodiment of the invention;

FIG. 2 is a schematic section through a security document similar to FIG. 1 with a modified security device;

FIG. 3 is a schematic section through a security document similar to FIG. 1 with another security device;

FIG. 4 is a schematic section through a security document with a security device formed from an embossed ink in a half-window area;

FIG. 5 is a plan view of a security document showing an example of an optically variable effect produced by an integrated security device;

FIG. 6 shows plan views of the focussing layer and image layer of the security document of FIG. 5;

FIG. 7 shows a plan view of a modification of the security document of FIG. 5;

FIG. 8 shows a plan view and close-up of an example of an image relief formation for use with some embodiments of the present invention;

FIG. 9 shows an alternative image layer for use with the configuration shown in FIG. 6;

FIG. 10 is a schematic cross section through a modified security document with the security device formed on an opaque substrate;

FIG. 11 is a schematic cross section through another security document with the security device formed on an opacified transparent substrate; and

FIG. 12 is a schematic cross section through a further embodiment of a security document in which the lens layer does not permanently overlie the image layer.

### DETAILED DESCRIPTION OF THE DRAWINGS

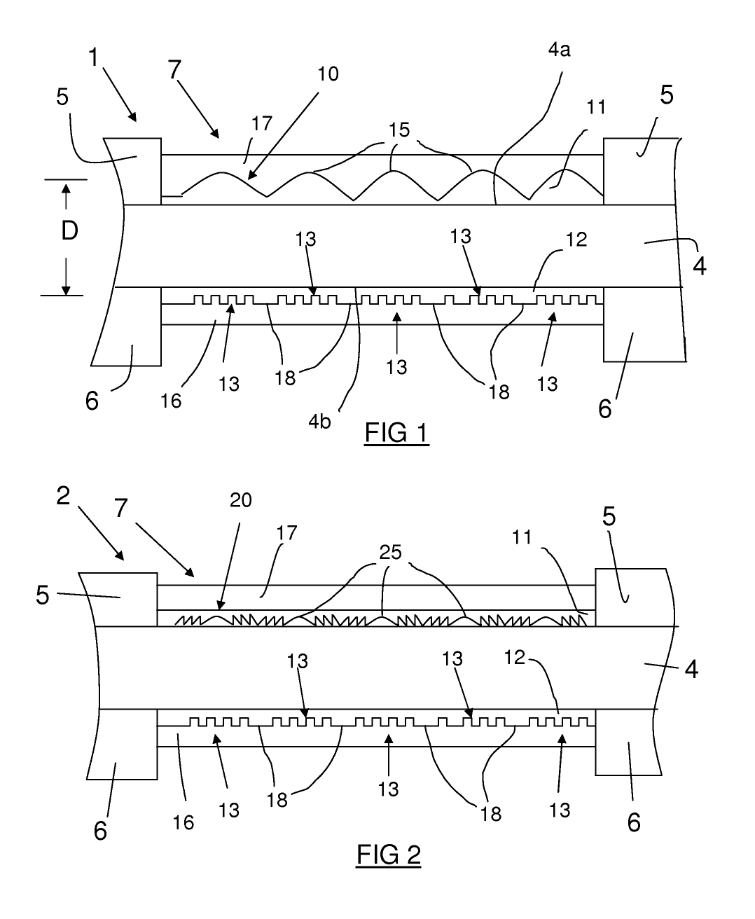

Referring to FIG. 1 there is shown a security document 1 comprising a substrate 4 of transparent plastic material and one or more opacifying layers 5,6 on each side of the substrate. The transparent substrate 4 is preferably formed from a transparent polymeric material such as a laminated structure of two or more layers of bi-axially oriented polypropylene. It will, however, be appreciated that other transparent or translucent polymeric substrates may be used in the present invention such as polyethylene and polyethyleneterephthalate (PET). The opacifying layers 5, 6 may comprise one or more coatings of opacifying ink applied to opposite sides of the substrate 4. Alternatively, the opacifying layers 5,6 may be formed from layers of paper or other opaque material laminated to opposite sides of the substrate 4 to form a hybrid substrate.

As shown in FIG. 1, the opacifying layers 5, 6 are omitted in a region of the security document 1 to form a transparent area or window 7. The security document is provided with an integral security device 10 in the window 7 as will be described below.

The security device 10 comprises a focussing layer 11 and an image layer 12. A first or upper surface 4a of the transparent substrate 4 has a plurality of embossed focussing element relief formations in the form of refractive microlenses 15 which have been embossed into a first layer of radiation curable ink to form the focussing layer 11. On the second, or lower, surface 4b of the device, there is a second layer of radiation curable ink into which have been embossed a plurality of diffractive image relief formations generally indicated at 13. The diffractive image relief formations 13 form the image layer 12.

The microlenses 15 and the image relief formations 13 may be formed from a radiation curable ink of the type described above, for example UV acrylate having a refractive index n of 1.47.

The thickness of the transparent substrate 4 preferably falls substantially within the range from about 50 to about 120 μm. The thickness of the radiation curable inks preferably does not exceed about 10 μm, and more preferably 5 μm. Thus the focussing layer 11 and the image layer 12 are separated by a predetermined distance D which is greater than 50 μm, preferably between about 60 and 100 μm, and more preferably between 65 and 90 μm.

The total thickness of the security document incorporating the security device preferably falls substantially within the range from about 60 to 140 μm. In the case of a transparent substrate covered by opacifying inks, the opacifying ink layers preferably have a total thickness falling substantially within the range from about 5 to 20 μm on each side of the substrate. When a hybrid paper/polymer substrate is used, the thickness(es) of the opacifying paper layer(s) may fall substantially within the range from about 10 μm to 45 μm.

The invention allows for relatively wide focussing elements and image elements to be used. Preferably the pitch of the focussing elements and/or image elements is at least about 50 μm.

The embossed image relief formations 13 may have various two-dimensional shapes in the plane of the image layer. For example, each image relief formation may form part of a larger overall image which is visible when viewed through the focussing layer 11. Alternatively, each image relief formation may be a complete image, such as a letter, number or geometrical shape.

The non-diffractive areas 18 of the image layer 12 form a background to the image-producing portions 13. The radiation curable ink of the image layer may be a partially transparent ink composition, for example containing gold or silver metallic pigment as described above. In this case, an observer viewing the device through focussing layer 11 will observe a coloured diffractive image formed by image elements 13 on a reflective gold or silver background formed by non-image areas 18.

A further layer 16 of a protective coating may be applied over image layer 12. This serves to protect the relief structure from physical damage, as well as preventing forgery by contact copying of the relief structure. The further layer 16 may be a substantially transparent material such as a high refractive index (HRI) coating, or it may be a reflective material such as a metallic coating. A HRI or metallic coating may serve to enhance the optical effect produced by the device, depending on the difference in refractive index between the coating and the image layer 12. For example, the optical effect may be completely visible in transmission, but only partially visible in reflection, or vice versa.

Alternatively, the image layer 12 may be printed in a substantially transparent ink to which a further layer 16 of ink having a different refractive index is applied, so that the ink fills the relief structures 13 and the background regions 18 will take on the appearance of the material of the further layer 16. The further layer 16 thus acts as a background layer in this embodiment.

For example, if a highly reflective material such as one of the gold or silver metallic ink compositions described above is employed, the viewer will see a coloured diffractive image produced by the relief structures 13, against a specularly reflecting gold or silver background, the specular reflection occurring from background regions 18.

Application of a non-metallic ink which includes a dye or coloured pigment will result in a diffractive, coloured and optically variable, image being visible against an optically invariable background having the colour of the dye or pigment.

It is also possible to structure the background regions 18, for example with a non-diffractive and aperiodic relief having a high degree of surface roughness, so that when a reflective layer of ink 16 is applied to the image layer 12, light which is incident on the background areas will be reflected non-specularly, i.e. diffusely, and the background will take on a substantially achromatic or matte appearance.

A protective coating 17, for example of a HRI material, may also be applied to the focussing layer 11.

The image relief formations 13 may have a constant spatial frequency f (=1/d, where d is the grating spacing) across the image layer. By virtue of the grating equation d(sin θₘ+sin θᵢ)=mλ, with θₙ, being the angular position of the m^{th} diffraction order, e, being the angle of incidence and λ the wavelength of the incident light, the colour of the image when viewed under polychromatic light will change as the observation angle changes, and different first-order diffraction maxima corresponding to different wavelengths come into view.

The spatial frequency and/or embossing depth may also be modulated across the image layer in order to produce more striking visual effects, such as fully tonal, multicoloured moiré magnified images.

It is also possible to form image elements 13 as sub-wavelength gratings, so that they act as zero-order gratings for a particular wavelength of light. For example, a grating with a grating spacing d of about 300 nm will have a strong reflection peak around 550 nm, i.e. it will appear substantially green. This type of structure also produces a further interesting effect in that it will display a colour shift on rotation about 90° in its own plane.

If sub-wavelength image relief formations 13 are formed, their spatial frequencies may also be modulated across the image layer in order to produce image elements having different colours. For example, some of the image elements 13 may have a first spatial frequency such that they produce green-coloured light in the zero diffraction order, while the remaining image elements may have a second spatial frequency such that they produce red-coloured light in the zero diffraction order. It will be appreciated that any number of different colours may be employed, so that multi-coloured magnified images displaying a colour shift on rotation through 90° may be formed.

The focussing layer 11 and image layer 12 are separated by a predetermined distance D, which will usually be similar to or approximately equal to the focal length of the focussing elements 15 so that the focussing elements are substantially “in focus” with the image elements. The distance D may also be decreased by tailoring the focal point size at the image layer 12 to the size of the image elements 13, so that the focal point size is approximately equal to or within a narrow range (for example, ±20%) of the image element size, as described in U.S. provisional application 61/157,309.

It is also possible to use “out of focus” focussing elements which have a focal length significantly higher than the distance D. For example, the focal length may be approximately double the distance D, eg when D is about 80-85 μm, focussing elements with a focal length of about 150-160 μm may be used.

If each image relief formation is a microimage in the form of a pattern or character and the microimages are substantially identical and repeat across the image layer with a particular repeat period or spatial frequency, and are viewed through lenses 15 which have a similar repeat period, then the observer will see an integral image composed of moiré fringes, each fringe being a magnified version of the individual microimages. The degree of magnification will depend on the difference in repeat period between the array of lenses in the focussing layer 11 and the array of microimages in image layer 12, and also on the relative angular orientation of the lens and image arrays.

The microimages may be formed as non-diffractive structures, e.g. as structures having a spatial extent on the order of several microns in one or both dimensions in the plane of the image layer. This is a much higher resolution than can be achieved by printing methods. Alternatively, they may be diffractive structures which have a similar overall spatial extent to the aforementioned non-diffractive structures, but which are diffractively substructured, i.e. each microimage is a diffraction grating or subwavelength grating.

It is also possible for the image relief formations to be more complex diffractive, reflective or refractive structures.

In one embodiment, each image relief formation 13 may be structured so that, in reflection under diffuse illumination by polychromatic light, it produces an image of part of a real or imagined object, the object appearing three-dimensional and achromatic to the viewer.

An example of such a structure is a relief formation including reflective facets (micromirrors), in which the slopes (angles) of the facets are modulated so as to reflect incident light in a manner which simulates reflection from the surface of the object, as described in PCT application WO 90/08338. A further example of a relief structure capable of producing a pseudo-3D effect, as described in PCT application WO 2006/013215, is a relief structure containing a series of diffractive zones, the spatial frequency and curvature of the diffractive grooves in each zone being arranged so that incident light is deflected in a manner which simulates reflection from the surface of the object.

Viewing image relief formations 13 of this nature under an array of lenses 15 can produce a pseudo-3D impression to the viewer which also varies as the viewing angle is changed.

In another embodiment, each of the image relief formations 13 may be of the above-described type, but producing a pseudo-3D image of the entire object. If the image relief formations 13 are substantially identical to each other and each underlie a lens 15, the device may produce a visual optical effect which is a rotated and magnified version of the pseudo-3D image, in accordance with the moiré magnifier principle discussed above.

In another embodiment, each image relief formation 13 may be structured as an array of micromirrors in which the angle between each micromirror and the substrate is modulated to produce a highly reflective optical effect. For example, the micromirror angles within an image relief formation 13 may be modulated so as to reflect incident light in a manner which simulates reflection from the surface of a real or imagined three-dimensional object, thus producing a pseudo-3D effect to the observer.

In general each focussing element of the focussing layer will overlie one image element 13 in use of the device, but more complex optically variable effects, such as animation, can be produced by applying image elements 13 which are derived from a plurality of interlaced (spatially multiplexed) images. For example, a “flipping image” effect could be provided by interlacing two images. The image elements 13 in this case would be the segments of the interlaced images, and each focussing element 15 would overlie a pair of image elements 13, one from each image.

In yet another example, the image elements 13 may include more than one type of effect-generating relief element, so that the image layer 12 includes, for example, an array of subwavelength grating microimages which produce a zero-order diffractive image which shifts colour on rotation, and an array of diffractive microimages which shift colour on tilting the device but not when the device is rotated. Two or more different types of optical effect may thus be produced by a single image layer 12.

It is also possible to employ diffractive lens structures as the focussing elements in order to provide a magnification effect, for example the Fresnel microlenses 25 of FIG. 2. FIG. 2 shows a security document 2 similar to that of FIG. 1 but with a modified security device 20. The security document 2 and device 20 of FIG. 2 are in all other respects substantially identical to the security document 1 and device 10 of FIG. 1. The Fresnel microlenses 25 may be formed as structures having a continuous profile as depicted in FIG. 2, or may be approximated by structures having a binary or multilevel profile, as known in the art.

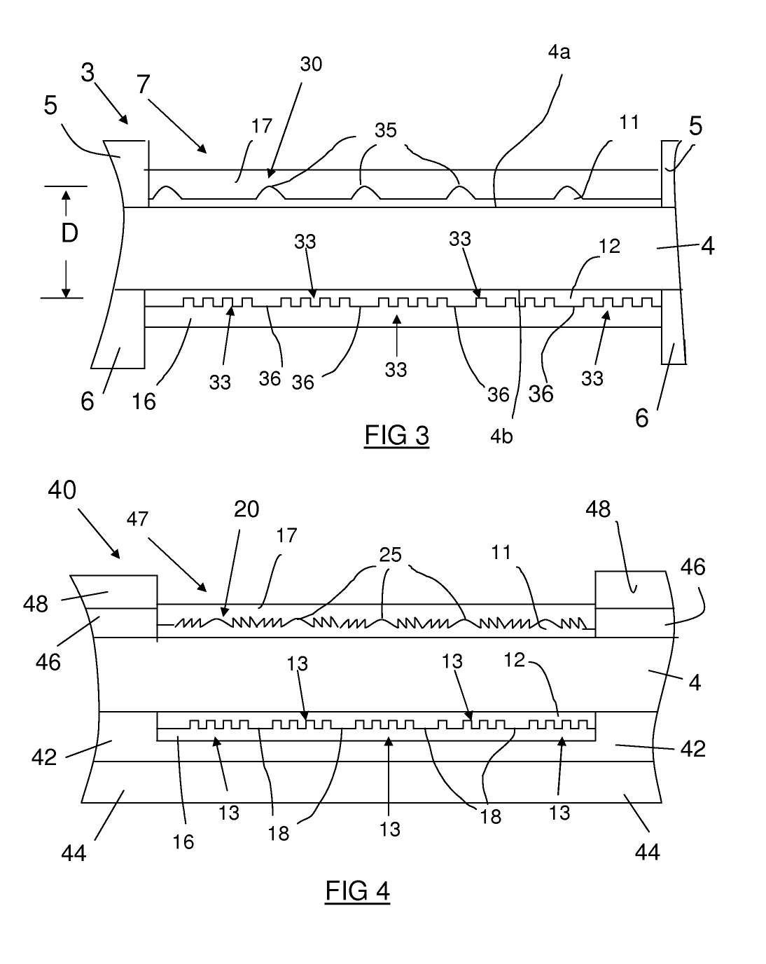

FIG. 3 shows a security document 3 similar to FIG. 1 but with a another modified security device 30. The security document 3 and device 30 of FIG. 3 are in all other respects substantially identical to the security document 1 and device 10 of FIG. 1. The security device 30 differs from that of FIG. 1 in that the embossed diffractive structures 33 in the image layer 12 form a diffractive background, and the focussing elements 35 of the focussing layer 14 overly non-diffractive areas 36 in the image layer.

Referring now to FIG. 4, there is shown a security document 40 incorporating the security device 20 of FIG. 2. The security document 40 includes a first opacifying layer 42 covering the side of the substrate 4 on which the image layer 12 is provided, and may optionally include a second opacifying layer 44 covering the first opacifying layer. On the opposite side of the substrate on which the focussing layer 14 is provided, a first opacifying layer 46 (and optionally a second opacifying layer 48) covers the substrate 4 except in the area of the device 20. The uncovered area 45 to which opacifying coatings 46, 48 are not applied thus forms in the upper surface of the document as shown a half-window area 47 containing the device 20.

The opacifying layers 42 and 44 may comprise any one or more of a variety of opacifying coatings. For example, the opacifying coatings may comprise a pigment, such as titanium dioxide, dispersed within a binder or carrier of heat-activated cross-linkable polymeric material. Alternatively, the substrate 4 of transparent plastic material could be sandwiched between opacifying layers of paper to which indicia may be subsequently printed or otherwise applied. It is also possible for the security documents to be formed from a paper or fibrous substrate which has an area cut-out with a transparent plastics insert inserted into the cut-out area to form a transparent window to which the ink composition is applied and embossed to form the focussing layer 11 and image layer 12.

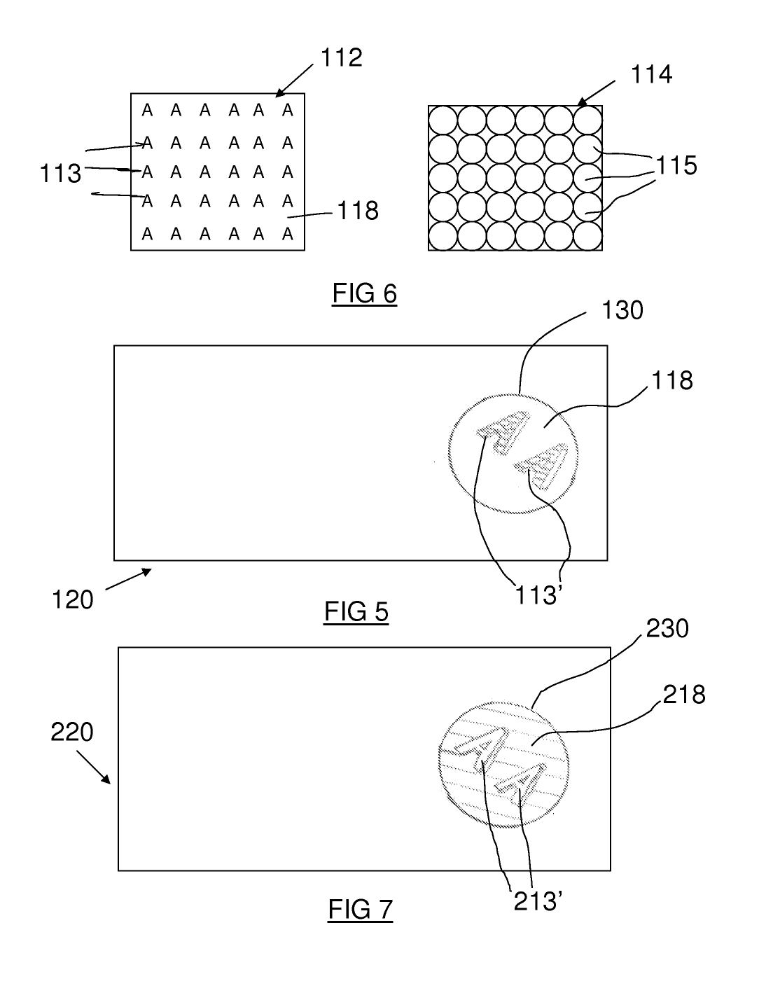

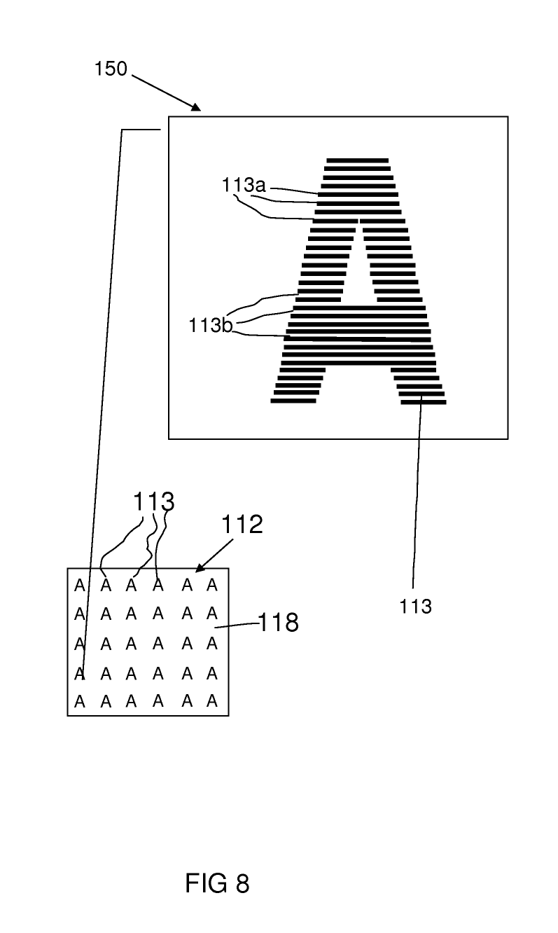

Referring to FIGS. 5, 6 and 8 there is shown a security document 120 including a window or half-window area 130 through which a moiré magnification effect is visible. FIG. 5 shows the security document in plan view. The security document 120 has a similar structure to that shown in FIG. 1, but with the image elements being embossed diffractive microstructures in the form of letters ‘A’ 113 in an image layer 112 as shown in the enlarged view of FIG. 6 which also shows an enlarged view of the microlenses 115 of the focussing layer 114. A greatly enlarged version of one of the image elements 113 is shown at 150 in FIG. 8. Areas 118 not occupied by letters ‘A’ 113 may be unstructured areas, or may be structured aperiodically so as to diffusely scatter incident light.

In FIG. 8, each image element 113 comprises a series of embossed diffractive grooves, in which dark lines 113a indicate embossed parts (grooves) and white lines 113b indicate unembossed parts (lands). Such a formation can provide a transition between light and dark images when viewed in transmission at different angles or if the security document is tilted.

The background layer (not shown) applied to the embossed image layer 112 is a preferably a translucent ink including a dye, so that when the image elements 113 are viewed through the focussing layer 114 including microlenses 115 and having similar (but not identical) pitch and rotational alignment as image layer 112, magnified and rotated letters 113′ showing a diffractive optically variable effect are visible against a non-diffractive coloured background 118, the background colour corresponding to the colour of the dye.

In FIG. 7, there is shown a modified version 220 of the security document 120 of FIG. 5, in which the roles of foreground and background have been reversed. In this instance, the image layer is embossed everywhere except in areas corresponding to the letters ‘A’, so that magnified and rotated versions 213′ having the colour of the dye are visible in windowed area 230 against a coloured diffractive background 218 corresponding to the embossed areas.

If the spacing between adjacent embossed 113a and unembossed 113b areas is made small enough, the image element may form a subwavelength grating which preferentially reflects light of a particular colour as described above.

It will also be appreciated that the spatial frequency of the grooves 113a may be modulated within an image element 113 to produce different colour effects. The depth of the embossed grooves may also, or instead, be modulated.

Image elements 113 in different regions of the image layer 112 may also have different spatial frequencies and/or embossing depths so as to produce different colours and/or brightness across the image layer 112.

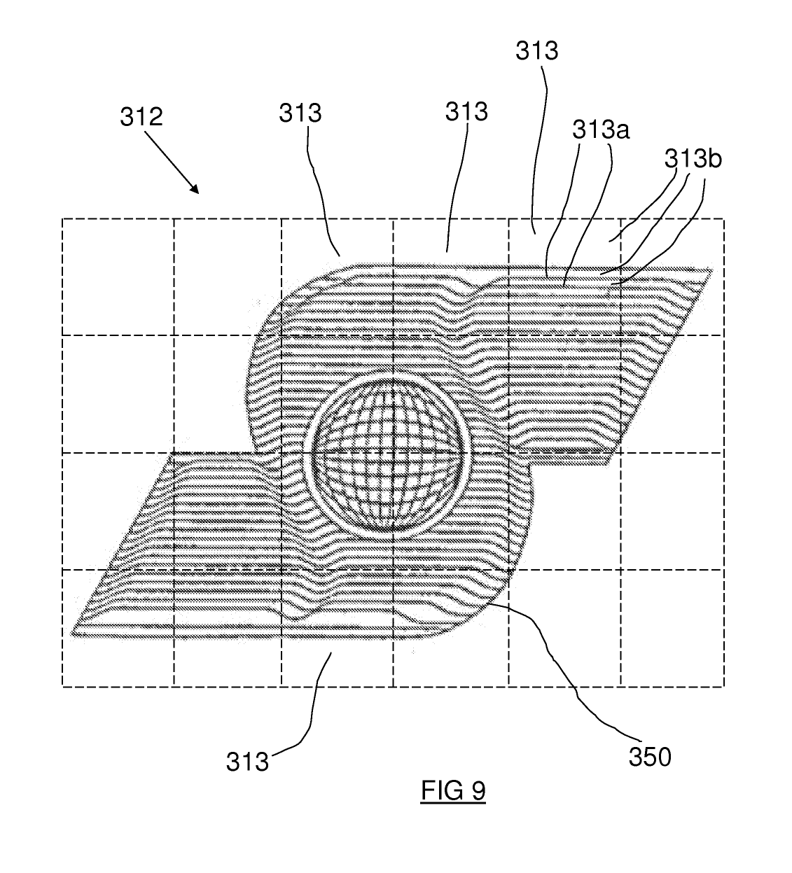

In FIG. 9 there is shown an alternative image layer 312 (not to scale) to the image layer 112 of FIGS. 5 and 7. In this embodiment, the image elements 313 (delineated by dotted lines) are generally non-identical. Image elements 313 comprise embossed grooves (dark lines) 313a and non-embossed areas 313b and the spacing and curvature of the embossed grooves may be modulated across the image layer 312. In use of a device featuring image layer 312, each image element 313 is viewed by a single lens in an overlying lens array 114, so that the impression produced to the viewer is of a diffractive image 350 which changes colour and which also appears to move and/or float as the viewing angle is changed.

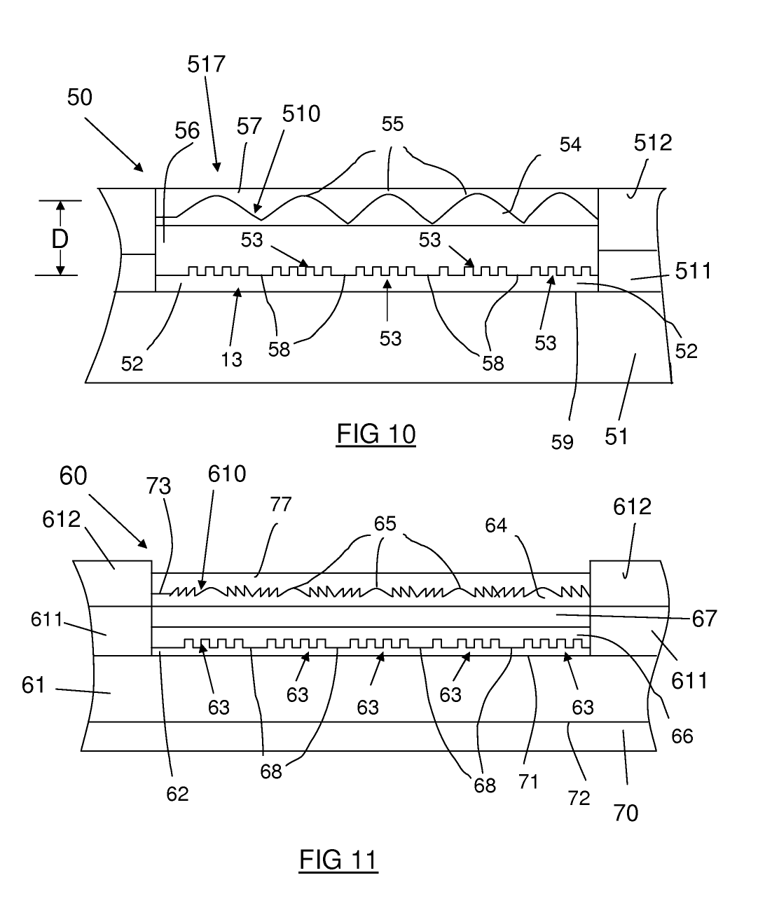

Referring now to FIG. 10, there is shown a modified security document 50 comprising an opaque substrate 51 provided with an integral security device 510. The security device 510 is similar to the security device 10 of FIG. 1 and comprises an image layer 52 and a focussing layer 54. The image layer 52 is formed from a layer of radiation curable ink applied to an area of a first surface 59 of the opaque substrate 51, following which diffractive image relief formations 53 are embossed into ink layer and the ink cured. An optical spacer layer 56, preferably a layer of a HRI material, is applied to image layer 52. A layer of radiation curable ink is then applied to the spacer layer 56 and microlenses 55 simultaneously embossed and cured in the ink layer to form the focussing layer 54. A further layer 57, preferably of HRI material may then be applied to protect the focussing layer 54. The unembossed non-diffractive areas 58 of the image layer form a background for the embossed image elements 53 but it will be appreciated that the arrangement can be reversed with the embossed diffractive areas forming a background for unembossed areas that form the image elements as described with reference to FIG. 3.

The surface of the opaque substrate 51 on the side on which security device 510 is provided may be covered by one or more other opaque layers, eg printed layers 511 and 512, except in the area where the security device is located. Thus, a half-window 517 is formed in the security document to produce a similar effect to FIG. 4.

In the embodiment of FIG. 10, the image layer 52 and focussing layer 54 are located on the same side of the substrate, and this may be advantageous in some manufacturing setups.

FIG. 11 shows a modified security document 60 having a security device 610 which is similar to the device 20 of FIGS. 2 and 4. The document 60 comprises a transparent substrate 61 to which an opacifying coating 70 has been applied on one surface 71. An image layer 62 of radiation curable ink is applied to the surface 72 of the substrate 61 opposite from the opacifying coating 70, and image relief formations 63 are formed by embossing and curing the radiation curable ink. A HRI coating 66 is then applied to image layer 62, and a further layer 67 of a substantially transparent optical spacer applied atop HRI coating 66. A second layer of radiation curable ink may then be applied to the outer surface 73 of the optical spacer layer 67, and focussing element relief formations 65 embossed and cured in the radiation curable ink to form focussing layer 64. A further layer of HRI material 67, which may be the same as, or different than, HRI coating 66, is then applied to focussing layer 64 to protect the lenses.

As in FIG. 10, the surface of the transparent substrate 61 on the side on which security device 610 is provided may be covered by one or more other opaque layers, eg printed layers 611 and 612, except in the area where the security device is located. Thus, a half-window 617 is formed in the security document to produce a similar effect to FIG. 4.

In each of FIGS. 10 and 11, the total thickness of the optical spacer, and HRI coating when provided, is preferably such that the image layer and the focussing layer are separated by a distance D greater than 50 μm. The total thickness of the security document preferably falls substantially within the range from about 60 to 140 μm, and more preferably is at least about 85 μm to allow for the thickness of the opaque substrate or opacified transparent substrate.

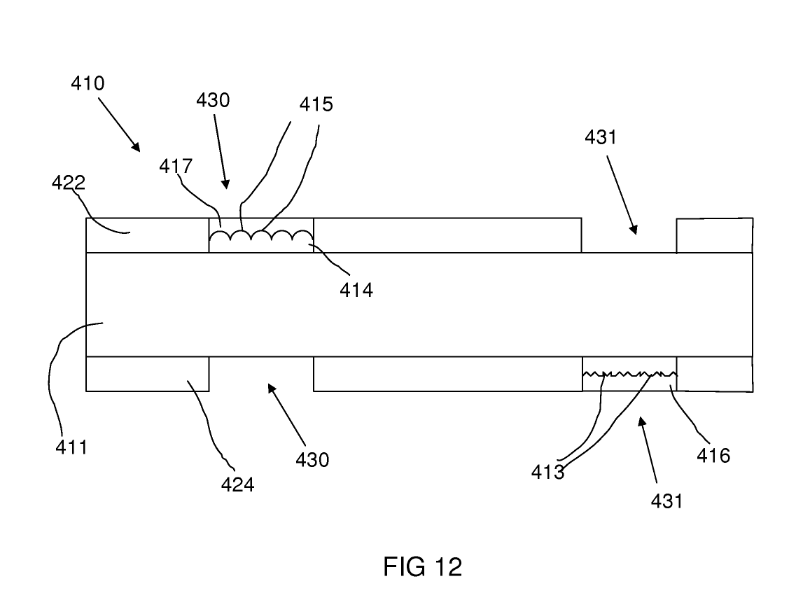

FIG. 12 shows another modified security document 410 which comprises a transparent substrate 411 having opacifying coatings 422, 424 applied to it apart from in the regions 430, 431, each of which forms a window region in the security document 410. In the first window 430 there is applied a focussing layer 414 of radiation curable ink into which focussing element relief formations 415 have been embossed and cured. A HRI material 417 is applied as a protective coating to the focussing element relief formations 415. In the second window region 431, on the opposite side of the substrate to the focussing layer 414, there is applied a second layer of radiation curable ink into which image relief formations 413 are embossed and cured to form image layer 412. Image relief formations 413 are protected by a second HRI protective layer 416.

By folding the security document 410 and bringing the two window regions 430, 431 into alignment, so that focussing layer 414 overlaps with image layer 412, a visible optical effect may become apparent, for example a diffractive or non-diffractive moiré magnification effect as described earlier, or a moving and/or floating coloured image. This “self-verifying” configuration of security document adds a further recognisable security feature for authentication of the document.

It will also be appreciated that the focussing layer 414 and image layer 412 may be located on the same side of the substrate 411, rather than on opposite sides as shown in FIG. 11, provided the substrate thickness and/or the focal length of the focussing elements 415 is adjusted accordingly.

In some applications, an intermediate primer layer (not shown) may be applied to the surface of the substrate 11, 51, 61, 411 before the embossable ink composition of layers 12, 14, 52, 54, 62, 64, 112, 114, 412, 414 is applied to improve the adhesion of the resulting embossed structure to the substrate.

The apparatus for embossing the UV curable ink to form the embossed structure may include a shim or a seamless roller. The shim or roller may be manufactured from any suitable material, such as nickel or polyester.

Preferably, the nickel shims are produced via a nickel sulphamate electroplating process. The surface of a photoresist glass plate holding a microscopic structure used to form a diffractive relief structure or array of microlenses may be vacuum metallised or sprayed with pure silver. The plate may then be placed in a nickel sulphamate solution and over a period of time molecules of nickel are deposited on the surface of the silver-coated photoresist, resulting in a master copy. Subsequent copies may be used in transferring the image for reproduction, or transferring to ultraviolet polyester shims or to make a seamless roller.

Polyester shims may be made by coating polyester with an ultraviolet curable lacquer and contact copying the master image and curing the transferred image by means of ultraviolet light.

Seamless cylinders may be made using a metallised transfer film with a sub-microscopic diffractive pattern or a microscopic lens pattern for microlenses thereon, which may be fixed and transferred to a cylinder coated with an adhesive. The metallised transfer film may be glued to the roller via a nip. The adhesive may then cured, preferably by heat. Once cured the transfer film is removed leaving the metallised layer with the sub-microscopic or microscopic pattern on the surface of the cylinder ie the roller. This is repeated until the cylinder is completely covered. This cylinder then may be placed in a casting tube and cast with silicone to make a mould. The sub-microscopic or microscopic pattern may be moulded to the inside surface of the silicone.

Once the silicone is cured the mould is removed and placed in a second casting tube. A casting roller may then be placed in the mould and cast with a hard resin, preferably cured with heat. Once cured the roller can be removed from the mould, where the pattern in the inside surface of the silicone has transferred to the outside surface of the resin cylinder and is ready for use, to transfer the sub-microscopic diffractive pattern or lens pattern on the surface of the cylinder into the surface of a printed ultraviolet curable lacquer on the first surface of a substrate.

In another embodiment a cylinder is coated with ultraviolet curable resin, placing a clear transfer film with a sub-microscopic diffractive pattern or a lens pattern to the surface of the ultraviolet resin via a nip and cured with ultraviolet light. The cylinder can then be subsequently cast, as described above and used to directly transfer the pattern into the surface of a printed ultraviolet cured lacquer on the first surface of a substrate.

The upper surface of the substrate may be printed with the embossable UV curable ink in discrete register with the window or half-window area, so that other subsequent printing can take place on non-registered areas as images/patterns outside the window or half-window area. The substrate may then pass through a nip roller to a cylinder carrying a sub-microscopic diffractive pattern or a lens pattern or image in the form of a nickel or polyester shim affixed to the surface of a cylinder. In a preferred embodiment the patterns are held on a seamless cylinder so that the accuracy of the transfer can be improved. The sub-microscopic diffractive pattern or lens pattern may then be transferred from the shim or seamless roller into the surface of the exposed ultraviolet curable lacquer by means of bringing the surface of the shim or seamless roller into contact with the surface of the exposed ultraviolet curable lacquer. An ultraviolet light source may be exposed through the upper surface of the filmic substrate and instantly cures the lacquer by exposure to ultraviolet light. The ultraviolet light sources may be lamps in the range of 200 watts to 450 watts disposed inside the cylinder, curing through the printed ultraviolet lacquer and fixing the transferred sub-microscopic diffractive pattern or lens pattern.

The method described above in which embossed relief structure security devices are formed by printing a transparent radiation curable ink onto a sheet, embossing the ink while still soft and simultaneously curing the ink with radiation, allows multiple security features to be formed in a sheet of banknotes or other security documents in which the security features are more accurately in register with the window or half-window areas of the individual documents of the sheet compared to other methods of applying embossed security devices such as diffraction gratings or holograms by transferring the security devices from a transfer sheet onto the security documents. This, in the present invention, is due at least in part to the registration of the security device being generated as an integral step of the printing process, and not being subject to issues of sheet fed registration in which tolerances are commonly greater than 1 mm.

Another advantage of the invention is that it allows security devices consisting of a focussing layer and an image layer to be integrated in a security document, such as a banknote, in a cost-effective manner, without substantially increasing the thickness of the document. In most instances, any additional height of the security device is not noticeable. The invention therefore allows for relatively wide focussing elements and image elements to be used without impacting on further printing or use of the device. The device formed from a focussing layer and an image layer is an overt security feature which allows for increased recognition by the public and provides greater difficulty in replication by the counterfeiter.

It will be appreciated that various modifications and alterations may be made to the embodiments of the present invention described above without departing from the scope and sprit of the present invention. For example, the different focussing layers and image layers in the different embodiments may be interchanged whilst the exemplary embodiments have been described with particular reference to a security document in the form of a banknote, it will be appreciated that the various aspects and embodiments of the invention have application to other types of security and identification documents including, but not limited to the following: credit cards, cheques, passports, identity cards, securities and share certificates, driver's licenses, deeds of title, travel documents such as airline and train tickets, entrance cards and tickets, birth, death and marriage certificates, and academic transcripts.

1. A security document comprising a substrate provided with an integral security device formed on the substrate, wherein the security device comprises an image layer and a focussing layer, the image layer including a plurality of embossed relief formations in a first radiation curable ink layer on a first surface of the document, the focussing layer including a plurality of embossed focussing element relief formations in a second radiation curable ink layer on a second surface, wherein the total thickness of the document falls substantially within the range from 60 to 140 mm and said first and second surfaces are separated by a predetermined distance greater than 50 mm to produce a visible optical effect when viewing the image layer through the focussing layer.

2. A method of manufacturing a security document with an integral security device including the steps of:
applying a first embossable radiation curable ink layer to a surface on one side of the document;
embossing the first radiation curable ink layer with a plurality of relief formations and curing with radiation to form an image layer; and
applying a second embossable radiation curable ink layer to a second surface;
embossing the second radiation curable layer with embossed focussing element relief formations and curing with radiation to form a focussing layer,
wherein the total thickness of the document falls substantially within the range from 60 to 140 mm and the first and second surfaces are separated by a predetermined distance greater than 50 mm to produce a visible optical effect when viewing the image layer through the focussing layer.

3. A security document or method according to claim 1 wherein at least one of the first and second radiation curable layers is embossed with diffractive relief structures.

4. security document or method according to claim 3 wherein the plurality of relief formations in the image layer include embossed diffractive structures.

5. A security document or method according to claim 4 wherein the embossed diffractive relief structures in the image layer form a diffractive background, and image elements in the image layer are formed by non-diffractive areas on the diffractive background.

6. A security document or method according to claim 4 wherein the embossed diffractive relief structures in the image layer form image elements on a non-diffractive background.

7. A security document or method according to claim 6 wherein the non-diffractive background is the same as the substrate on which the security device is formed.

8. A security document or method according to claim 1 wherein the embossed focussing element relief formations are diffractive structures.

9. A security document or method according to claim 1 wherein the visible optical effect produced when viewing the embossed relief formation in the image layer through the focussing layer is a coloured image.

10. A security document or method according to claim 1 wherein the plurality of relief formations in the focussing layer and/or image layer include microlens structures.

11. A security document or method according to claim 1 wherein the plurality of relief structures in the focussing layer and/or the image layer form at least one Fresnel lens, zone plate or photon sieve.

12. A security document or method according to claim 1 wherein the plurality of relief structures in the focussing layer and/or the image layer include micromirror elements.

13. A security document or method according to claim 1 wherein the visible optical effect produced when viewing the relief formations of the image layer through the focussing layer includes a magnified moiré effect.

14. A security document or method according to claim 1 wherein the visible optical effect produced when viewing the relief formations of the image layer through the focussing layer includes a three-dimensional effect.

15. A security document or method according to claim 1 wherein the visible optical effect produced when viewing the relief formation of the image layer through the focussing layer includes a moving or a floating image.

16. A security document or method according to claim 1 wherein the substrate is formed from transparent material, the relief formations of the image layer are embossed into a radiation curable layer applied on one side of the substrate, and the relief formations of the focussing layer are embossed into a radiation curable layer applied on the opposite side of the substrate.

17. A security document or method according to claim 16 wherein the thicknesses of the transparent material and of the radiation curable layers on opposite sides of the substrate determine the predetermined separation of the image layer and focussing layer.

18. A security document or method according to claim 1 wherein the relief formations of the image layer and the focussing layer are embossed into radiation curable layers applied to surfaces on the same side of the substrate, said surfaces being separated by a substantially transparent intermediate layer.

19. A security document or method according to claim 18 wherein the substrate is an opaque substrate, such as paper or a paper/polymer hybrid substrate.

20. A security device or method according to claim 1 wherein at least one reflective or high refractive index coating is applied to the embossed relief formations of the image layer and/or the focussing layer.

21. A security document or method according to claim 18, wherein the thicknesses of the substantially transparent intermediate layer, the radiation curable layers and any high refractive index coatings determine the predetermined separation of the image layer and/or the focussing layer.

22. A security document according to claim 1 wherein the security device is incorporated within a window or half-window of the security document.

23. A method according to claim 2 wherein at least one of the first and second radiation curable ink layers is embossed while soft to form the relief formations and cured with radiation at substantially the same time as the embossing step to fix the embossed relief formations.
